(19) United States
(12) Patent Application Publication
(10) Pub. No.: US 2013/0232867 A1
(43) Pub. Date: Sep. 12, 2013

(54) OCEANIC ALGAL FOSTERING AND FISHERY INITIATING AND MAINTAINING SYSTEM

(71) Applicant: St.Jean Orridge, Cavello Bay (BM)

(72) Inventor: St.Jean Orridge, Cavello Bay (BM)

(21) Appl. No.: 13/783,144

(22) Filed: Mar. 1, 2013

Related U.S. Application Data
(60) Provisional application No. 61/609,823, filed on Mar. 12, 2012.

(51) Int. Cl. A01K 61/00; A01G 33/00

(52) U.S. Cl. CPC A01K 61/00; A01G 33/00
USPC 47/1.4; 119/215

(57) ABSTRACT

A system for algal fostering and fishery initiating and maintaining, and for reducing greenhouse gases, comprising a plurality of pumps having hoses for drawing deep, cold, and nutrient rich water from the bottom of an ocean and pumping it to the ocean's surface, and a plurality of heat exchangers drawing the heat from the warmer waters surrounding the hoses, the plurality of heat exchangers being in heat communication with at least a portion of the hoses, for gradually warming the ascending deep, cold and nutrient rich water during its ascent through the hoses, so that it is substantially at ocean's surface water temperature at the time it arrives at ocean's surface.

### CROSS-REFERENCE TO RELATED APPLICATIONS

This application claims the benefit of U.S. Provisional Application No. 61/609,823 filed Mar. 12, 2012, which is hereby incorporated by reference, to the extent that it is not conflicting with the present application. This application also relates to U.S. Provisional Application No. 61/554,914 filed Nov. 2, 2011.

### BACKGROUND OF THE INVENTION

1. Field of the Invention

The invention relates generally to oceanic installations and more particularly to systems and methods for oceanic algal fostering and for initiating and maintaining oceanic fisheries.

2. Description of the Related Art

It is known that if, in suitable geographical locations, the ocean's deeper nutrient rich waters is pushed to the surface, algal blooms and fisheries may rapidly and abundantly developed under certain conditions.

Nutrient rich water to the surface, where sunlight can reach it, may provide the environment for massive broad spectrum algal growth. The natural result of this is that an ecosystem of marine life may develop to feed on this provided food source, and thus, a prolific, natural, wild fishery may occur.

Where this phenomenon occurs naturally (e.g. along the coast of Peru/Chile, California, Alaska or South Africa) it may be observed that some of the greatest concentrations of marine life on the planet have naturally proliferated. The phenomenon translates into great economic benefits for the respective regions and for the world at large.

Discussions about how to artificially replicate this extraordinary phenomenon by pumping nutrient rich deep ocean waters to the surface for fisheries related initiatives have been held for years. However, the discussed approaches appear to leave unaddressed/unresolved the very important problems related to the natural tendency of the cold, dense, nutrient rich water to sink back to the bottom of the ocean and/or the problem of disturbing the vertical integrity of the ocean's thermoclines. A solution is needed to solve these problems by employing a system and process for warming up the ascending waters. Another reason/benefit of warming the ascending waters is that algal growth can be accelerated in warmer waters as can fish growth and conversion ratios (food eaten to bodyweight gained may also be higher {i.e. fish gain more weight per pound of food eaten}). Also unaddressed appears to be a means to actively and rapidly re-aerate/re-oxygenate the deeper, nutrient rich waters, which would offer increased efficiency and performance to such a system.

Thus, there is a need for a new and improved system and method to address the problems described above.

### BRIEF SUMMARY OF THE INVENTION

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

In one exemplary embodiment, when the cold, nutrient rich, deep waters are brought to the surface, these ascending cold waters are brought into contact with one or more heat exchangers which act to warm the ascending cold water inside the hoses, drawing the heat energy directly from the warmer waters surrounding the hoses. This design ensures that the nutrient rich deep waters arrive at the surface at the surface ambient temperature. One reason for this is so that the colder, denser, nutrient rich deep waters may be brought to the surface without immediately sinking back to the bottom of the ocean (due to their greater density). Another objective of this design is to maintain the vertical integrity of the ocean's thermoclines as will be explained in more detail later.

In another exemplary embodiment, airlift pumping is used at least for some stage of the pumping leg. This acts to rapidly and actively re-aerate/re-oxygenate the deep ocean water thus offering an accelerated process as compared to natural wave mixing.

The above embodiments and advantages, as well as other embodiments and advantages, will become apparent from the ensuing description and accompanying drawings.

### BRIEF DESCRIPTION OF THE DRAWINGS

For exemplification purposes, and not for limitation purposes, embodiments of the invention are illustrated in the FIGURES of the accompanying drawings, in which:

FIG. 1 is a schematic diagram depicting a system for oceanic algal fostering and for initiating and maintaining oceanic fisheries, according to several embodiments.

### DETAILED DESCRIPTION OF THE PREFERRED EMBODIMENTS

What follows is a detailed description of the preferred embodiments of the invention in which the invention may be practiced. Reference will be made to the attached drawings, and the information included in the drawings is part of this detailed description. The specific preferred embodiments of the invention, which will be described herein, are presented for exemplification purposes, and not for limitation purposes. It should be understood that structural and/or logical modifications could be made by someone of ordinary skills in the art without departing from the scope of the invention. Therefore, the scope of the invention is defined by the accompanying claims and their equivalents.

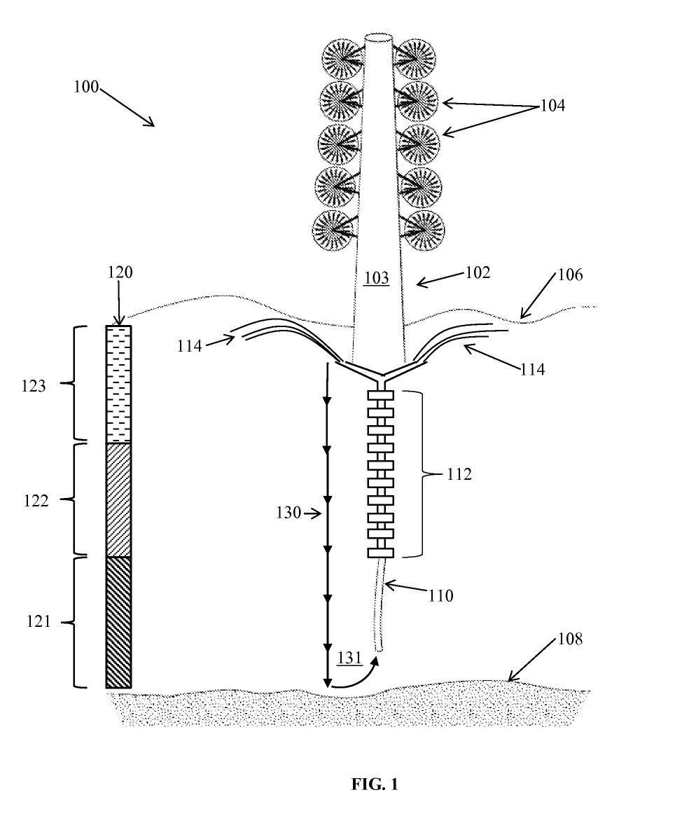

Referring to FIG. 1, a schematic diagram depicting a system for oceanic algal fostering and for initiating and maintaining oceanic fisheries, according to several embodiments, is shown. As stated earlier, if the ocean's deeper, cool, and nutrient rich waters 131, from near the bottom 108 of the ocean, are pushed to the surface 106, algal blooms and fisheries may rapidly and abundantly develop under certain conditions. This is in part because nutrient rich water brought to the surface 114, where sunlight can reach it, may provide the environment for massive, broad spectrum algal growth. The natural result of this is that an ecosystem of marine life may develop to feed on this provided food source, and thus, a prolific, natural, wild fishery may occur. To increase the likelihood of success of this process, the deep water 131, when arriving at the surface 106 (see 114—pumped water arriving at the surface of the ocean), has to be warmed and properly oxygenated, as will be explained in further details hereafter.

The system 100 depicted in FIG. 1 is preferably comprised of a series of anchored or GPS self-positioning floating pumps 102 with hose(s) 110 extending down into the deeper, colder, nutrient rich waters 131 of the ocean. Preferably, the pumping mechanisms use wave motion, wind, or solar power as their energy sources, which make them cost effective and ecofriendly. If wind energy is used, as shown, each pump 102 may include a pump tower 103 on which one or more wind turbines 104 may be installed. More details about the exemplary pump depicted in FIG. 1 and other exemplary pumps that may be used to practice the invention are presented in applicant's U.S. Non-provisional application Ser. No. 12/833,899, filed Jul. 9, 2010, which is hereby incorporated by reference, to the extent that it is not conflicting with the present application.

As the deep, cold, nutrient rich waters 131 are pumped to the surface they pass through a series of preferably passive heat exchangers 112, schematically depicted in FIG. 1. The heat exchangers 112 may act through simple thermal conduction to warm the ascending cold waters inside the hose(s) 110, drawing the heat directly from the warmer waters surrounding the hose(s) 110. These surrounding waters, which are reciprocally cooled, will be on average displaced downwards (see 130) thus spatially replacing the nutrient rich bottom waters 131 that are being drawn to the surface through the hose(s) 110. The resulting effect of the heat exchangers is that, the nutrient rich waters arrive at the surface at the ambient surface temperature.

Thus, the heat exchangers' action is very important for at least two reasons. First, the heat exchangers act to ensure that the vertical integrity of the ocean's natural thermoclines 120 is maintained and that heat energy is not being pushed deeper into the world's seas and oceans. The warming of the ascending waters to surface ambient temperature is also important for another reason. Warmer, surface ocean water is less dense than the deeper, colder water below it. If deep colder nutrient rich waters are brought to the surface without being warmed their greater density means that they will tend to simply plunge straight back down to the depths, thus immediately leaving the euphotic zone/layer 123 with their nutrient content and negating the pumping effort made to raise them to the surface.

It should be noted that, although the ocean's temperature gradient is often fairly complex (e.g., the temperature gradient may be different at different depth levels), for simplicity purposes, the ocean's natural thermocline 120 (herein, thermocline means depth vs. temperature or temperature at a given depth) is schematically represented in FIG. 1 as having only three layers or zones: cold layer 121, intermediate layer 122 and warm layer 123.

It should also be observed that the heat exchangers 112 may be placed only on a portion of the vertical length of the hose(s) 110, typically the higher portion, as shown in FIG. 1, or on the entire vertical length of the hose(s) (i.e., within all three layers 121-123). When selecting the proper vertical length of heat exchangers factors such as costs, the actual thermocline of the ocean area where the system is to be installed, heat exchangers' capacity and efficiency to transfer heat, and so on, may need to be considered. For example, if properly sized and calibrated, heat exchangers may be used only in the upper portion, where the water is warmer, thus, costs may be reduced while achieving substantially the same amount of heat transfer given the higher temperature difference between the deep/cold water and the upper/warmer water. Thus, economic best fit to achieve heat exchange will be applied in each situation.

Any type of heat exchangers known in the art may be used. However, likely preferred heat exchangers will be made from titanium material as used in salt water applications to minimize corrosion. Also, to reduce costs, likely preferred will be a custom and simple heat exchanger, such as a simple metal tube, perhaps only 2 feet long, inserted regularly along the hose as necessary, and having internal fins to facilitate heat transfer.

The system has to be properly calibrated in terms of speed of the ascending water, size/type of heat exchangers, hose size, pumps' power and so on, in order to achieve the results described above.

Thus, the system 100 acts to pump up the ocean's deep nutrient rich waters to the surface in geographical locations suitable for developing algal blooms and fisheries.

The use of the heat exchangers to bring the nutrient rich waters to surface ambient temperatures and the ability to select the geographical location of the system to maximize sunlight, and optimize growing temperatures mean that the system has the ability to provide unparalleled efficiency in algal and fish growth. The results will surpass even the existing wild upwelling fisheries as they have the disadvantage of cold water associated with their nutrient content, which slows algal and fish growth and minimizes conversion ratios of food consumed to fish body mass gained.

Furthermore, by incorporating airlift pumping technology in the system disclosed herein, at least for some stage of the pumping leg, the ascending, nutrient rich waters are aerated and oxygenated actively, rapidly and automatically by the time they reach the surface. This improvement further stimulates the algal and fish growth.

While the system and method described herein have the function of creating and maintaining an intensive oceanic upwelling fishery, through the constant growth of algae and fish, the system also acts to fix tremendous quantities of CO2 gas into solid organic matter, which has many obvious benefits today when the world is faced with serious CO2 pollution problems.

Outgassing of CO2 has been a noticeable phenomenon in naturally occurring upwelling zones. CO2 gas that has been absorbed by the oceans from the atmosphere helps lower atmospheric CO2 content, but is causing a knock on acidification (CO2+H2O=HCO3−+H+) and potential super-saturation of oceanic waters with CO2. Cold water can hold relatively more CO2 in solution than warmer water which means that colder deeper waters brought to the surface and warmed will release some of their CO2 gas from solution. This is what is happening when outgassing is observed.

Accurate scientific quantification of the balance between outgassing and CO2 uptake and sequestration by algae and fish (through marine snow and harvest of algae and fish products) should be conducted. However, in the overall carbon cycle balance it is evident that the more carbon that is fixed into solid form the less there is available to enter the (atmospheric=ocean solubilized=ocean acidification) equilibrium continuum. Consistently larger base populations of algae and fish on a global scale will remove significant CO2 from the atmosphere. Fish meal fertilizers harvested from created oceanic fisheries, used in agricultural crops result in marked increases in CO2 sequestration into crop soils. The same is true for human deactivated sewage sludge fertilizers where humans have consumed fish proteins from the created upwellings.

Thus, this system has the potential to address some of today's major pressing issues (greenhouse carbon dioxide accumulation, oceanic acidification and fishery depletion) in a way that mimics a completely natural system using technology that is simple and cost effective. The potential is there for a truly win/win economic and environmental solution.

Again, by bringing nutrient rich water to the surface where sunlight can reach it, the system and method for oceanic algal fostering and for initiating and maintaining oceanic fisheries disclosed herein provides the environment for massive broad spectrum algal growth. The natural result of this is that an ecosystem of marine life will develop to feed on this provided food source, and thus a prolific natural, wild fishery can actually be ‘created’ and developed. In fact, by virtue of the creation of new major world class fisheries, the pressure on existing fisheries will be reduced and with overall fish growth potential being greater on a planetary scale, a reset to maximized sustainable yield harvesting has the potential to be practiced.

The objective of the system is to bring re-oxygenated and nutrient rich water to the surface, warming it to surface temperatures with heat exchangers on the way.

If the system is set up in a location where there are surface and deep oceanic currents there will constantly be new deep nutrient rich water arriving at the suction point to be pumped to the surface. Also, the waters surrounding the hoses which are being reciprocally cooled and sinking will be moved away from the system by mid-level and surface currents, and thus, will not sink directly vertically down to the base of the hose and immediately be drawn to the surface even though they have little nutrient content. Thus, locations with oceanic currents are where optimal performance could be expected.

The system can also work in areas where there are no oceanic currents; however, there will be a greater chance for immediate recirculation of the waters surrounding the pipe which are reciprocally cooled and are tending to sink directly to the bottom with potential to be pumped to the surface themselves even though they are not ‘deep water’ with nutrient rich content.

GPS self-locating pumps will likely be much cheaper and less problematic than trying to maintain long lengths of anchor cable and would allow for programmed routes when in areas with little deep oceanic current flow. It may prove more cost effective to make the pumps minimally motile and have a GPS system on board, rather than maintaining a deep ocean cable mooring. Oceanic currents, tidal effects, etc, mean that the pumps in the system will want to move.

By making the pumps minimally motile and having GPS systems on board, a program can be written where pumps maintain a certain distance from one another (e.g., one mile apart) across the prevailing current. The pumps would then adjust their position automatically, as required, using GPS.

Again, the pumps described herein above may use wind and/or solar and/or wave motion energy or other forms of renewable/green energy. The renewable energy will be harvested and stored from all of these clean sources, then used for pumping deep waters and for geographical positioning of the pumps, as needed.

It may be advantageous to set forth definitions of certain words and phrases used in this patent document. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

Throughout this description, the embodiments and examples shown should be considered as exemplars, rather than limitations on the apparatus and procedures disclosed or claimed. Although many of the examples involve specific combinations of method acts or system elements, it should be understood that those acts and those elements may be combined in other ways to accomplish the same objectives. Acts, elements and features discussed only in connection with one embodiment are not intended to be excluded from a similar role in other embodiments.

For means-plus-function limitations recited in the claims, if any, the means are not intended to be limited to the means disclosed in this application for performing the recited function, but are intended to cover in scope any means, known now or later developed, for performing the recited function.

Although specific embodiments have been illustrated and described herein for the purpose of disclosing the preferred embodiments, someone of ordinary skills in the art will easily detect alternate embodiments and/or equivalent variations, which may be capable of achieving the same results, and which may be substituted for the specific embodiments illustrated and described herein without departing from the scope of the invention. Therefore, the scope of this application is intended to cover alternate embodiments and/or equivalent variations of the specific embodiments illustrated and/or described herein. Hence, the scope of the invention is defined by the accompanying claims and their equivalents. Furthermore, each and every claim is incorporated as further disclosure into the specification and the claims are embodiment(s) of the invention.

What is claimed is:

1. A system for algal fostering and fishery initiating and maintaining, and for reducing greenhouse gases, comprising: a plurality of pumps having hoses for drawing deep, cold, and nutrient rich water from the bottom of an ocean and pumping it to the ocean's surface, and a plurality of heat exchangers drawing the heat from the warmer waters surrounding the hoses, the plurality of heat exchangers being in heat communication with at least a portion of the hoses, for gradually warming the ascending deep, cold and nutrient rich water during its ascent through the hoses, so that it is substantially at ocean's surface water temperature at the time it arrives at ocean's surface.

2. The system of claim 1 wherein the plurality of pumps uses airlift pumping technology for at least a portion of the pumping distance, such that the ascending deep, cold and nutrient rich water arrives re-oxygenated at the ocean's surface.

3. The system of claim 2 wherein the plurality of pumps self-propels using wind energy, and wherein, each of the plurality of pumps comprises a pump tower on which at least one wind turbine is installed.

4. The system of claim 2 wherein the plurality of pumps are configured to harvest and store at least one form of clean energy and to use it for pumping deep water and for geographically positioning themselves, wherein the at least one form of clean energy is a member of a group consisting of wind energy, wave motion energy and solar energy.

5. The system of claim 2 wherein each of the plurality of pumps uses GPS functions and self-propelling components to position itself according to programmed routes.

6. A method for algal fostering and fishery initiating and maintaining, and for reducing greenhouse gases, comprising: installing a plurality of pumps having hoses for drawing deep, cold, and nutrient rich water from the bottom of an ocean and pumping it to the ocean's surface, and installing a plurality of heat exchangers for drawing heat from the warmer waters surrounding the hoses, the plurality of heat exchangers being in heat communication with at least a portion of the hoses, for gradually warming the ascending deep, cold and nutrient rich water during its ascent through the hoses, so that it is substantially at ocean's surface water temperature at the time it arrives at ocean's surface.

7. The method of claim 5 wherein the plurality of pumps uses airlift pumping technology for at least a portion of the pumping distance, such that the ascending deep, cold and nutrient rich water arrives re-oxygenated at the ocean's surface.

8. The method of claim 6 wherein the plurality of pumps self-propels using wind energy, and wherein, each of the plurality of pumps comprises a pump tower on which at least one wind turbine is installed.

9. The method of claim 6 wherein each of the plurality of pumps uses GPS functions and self-propelling components to position itself according to programmed routes.

10. The method of claim 6 wherein the plurality of pumps are configured to harvest and store at least one form of clean energy and to use it for pumping deep water and for geographically positioning themselves, wherein the at least one form of clean energy is a member of a group consisting of wind energy, wave motion energy and solar energy.
